(19) United States
(12) Patent Application Publication
(10) Pub. No.: US 2015/0189242 A1
(43) Pub. Date: Jul. 2, 2015

(54) SYSTEM FOR CAPTURING AND RETREIVING INFORMATION RELATED TO TRAFFIC

(71) Applicant: Seow Loong TAN, (US)

(72) Inventor: Seow Loong Tan, Singapore (SG)

(21) Appl. No.: 14/405,833

(22) PCT Filed: Jun. 5, 2013
(86) PCT No.: PCT/SG2013/000236

§ 371 Date: Dec. 5, 2014

(30) Foreign Application Priority Data
Jun. 5, 2012 (SG) 201204142-2

(51) Int. Cl. H04N 7/18; G06F 17/30; G06K 9/00; G08G 1/09

(52) U.S. Cl. CPC H04N 7/181; G08G 1/093; G06F 17/30253; G06K 9/00671; G06K 9/00771; G06K 9/00791; G06K 2209/15

(57) ABSTRACT

The system for capturing and retrieving information related to traffic comprises a mobile phone based camera configured to capture images or videos of automobiles, the images including the license plate as well. The images or videos captured by the mobile phone based camera is either processed in the mobile phone itself or transmitted over to a back end computer over a 3G or 4G transmission link and processed to extract the license plate number. If the images or videos are processed in the mobile phone, then the extracted license plate number is transmitted over to the back end computer. In the back end computer, the license plate number is used to search a database of information containing traffic violations associated with vehicle's license plate numbers. The search results are then transmitted over to the mobile phone by the back end computer over the transmission link.

### TECHNICAL FIELD OF INVENTION

This invention relates to a system for capturing and retrieving information related to traffic. This invention has particular, but not exclusive, application in the field of managing vehicular traffic and traffic law enforcement.

### BACKGROUND

Law enforcement on roads and traffic management have long been done by various governmental setups and is becoming increasingly important and critical in the current scenario, especially with increasing automobiles on the roads and associated safety of drivers and pedestrians on the roads. Appropriate traffic law enforcement and traffic management is essential to the growth and progress of a society.

In some places, a law enforcer or traffic police personnel police the streets and roads to check if vehicles have been parked in non-parking areas or if any vehicle flouts traffic rules much to the inconvenience of other fellow drivers. Usually, the law enforcer or the police personnel notes down the number of the vehicle or takes images of the vehicle and checks later in the office if the vehicle has any previous violation record. Depending on the violation record of the vehicle, the current penalty may vary. For instance, if a vehicle flouts traffic laws for the first time, the penalty may not be as severe as the penalty when the vehicle flouts the traffic laws the second time. It usually takes time in determining if the vehicle is a first time offender or a second time offender or has offended more than twice.

Moreover, if a law enforcer or a traffic police personnel happens to spot a vehicle and he wants to obtain more information about the vehicle, in terms of the owner, violation record etc, he has to contact somebody in the traffic control centre or go there and get the information for himself or herself This involves quite a bit of time in gathering the information and if the vehicle is parked only for a short time, then the time to gather the information becomes very critical.

### SUMMARY

In accordance with an aspect of the invention, there is disclosed a system for capturing and retrieving information related to traffic. The system comprises an image capture device for capturing visual information of the traffic. The system further comprises a back end computing system which is capable of communicating with the image capture device over a transmission link. The back end computing system comprises a database of information associated with the traffic and is further configured to retrieve information associated with at least one element of the traffic.

BRIEF DESCRIPTION OF DRAWINGS

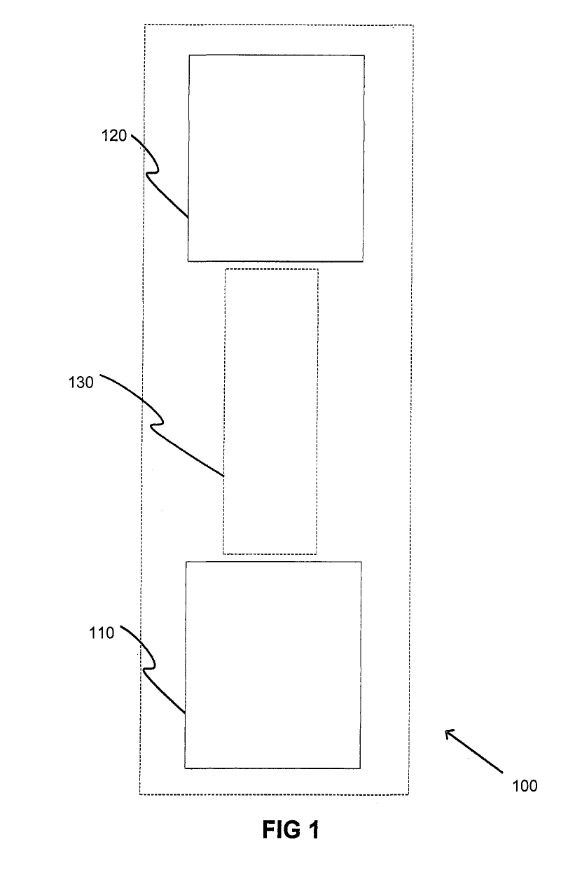

FIG. 1 shows a high level architecture of a system for capturing and retrieving information related to traffic

### DETAILED DESCRIPTION

In the disclosure herein, consideration or use of a particular element number in a given FIGURE or corresponding descriptive material can encompass the same, an equivalent, or an analogous element number identified in another FIGURE or descriptive material corresponding thereto.

In the present disclosure, the term “set” corresponds to or is defined as a non-empty finite organization of elements that mathematically exhibits a cardinality of at least 1 (i.e., a set as defined herein can correspond to a singlet or single element set, or a multiple element set), in accordance with known mathematical definitions. In general, an element of a set can include or be a system, an apparatus, a device, a structure, an object, a process, a physical parameter, or a value depending upon the type of set under consideration.

FIG. 1 shows a high level architecture of a system 100 for capturing and retrieving information related to traffic. As illustrated in FIG. 1, the system 100 comprises an image capture device 110 for capturing visual information of the traffic. Here, traffic refers to automobile or vehicular traffic on roads or streets and an element of the traffic refers to an automobile or a vehicle. The image capture device 110 can be held in the hands of the user. In this case, the user is a traffic law enforcer or a policeman. The image capture device 110 can be a standalone and portable image capture device such as a camera with data transmission capabilities and display capabilities. Alternately, the image capture device 110 can be a part of a portable device such as a camera in a mobile apparatus, specifically a mobile phone.

The system 100 further comprises a back end computing system 120, the back end computing system 120 being configured to communicate with the image capture device 110 through a transmission link 130. The transmission link 130 is for communication and transmission of data between the image capture device 110 and the back end computing system 120. The transmission link 130 can be a wireless transmission link, such as 3G or 4G of any such telecommunication based protocol. Moreover, the back end computing system 120 comprises a database of information related to the traffic for the purposes of retrieving information associated with the element of the traffic. To elaborate, the information in the database described above comprises information about traffic violations associated with a first subset of automobiles from the totality of automobiles registered in a jurisdiction. The traffic at any point in time when the image capture device 110 captures visual information comprises a second subset of automobiles of the totality of automobiles registered in the jurisdiction. For instance, if automobiles A1, A2, A3, A4 and A5 are registered in a jurisdiction, they form the totality of automobiles registered in the jurisdiction. If A2, A3 and A5 have violated traffic laws earlier, then A2, A3 and A5 will be in a database of traffic violations and they will form the first subset of automobiles. If the image capture device 110 is directed at the traffic comprising automobile A4, then A4 forms the second subset of automobiles. The second subset of traffic is not limited to one automobile and there can be more than one automobile as well.

The visual information refers to still images and/or moving images of the vehicles in the traffic, specifically automobiles. The automobile types can be cars, motorcycles, scooters, light cargo vehicles, heavy cargo vehicles and buses. Cars can be sedans, MPVs, SUVs etc. Light cargo vehicles can be vans, pickups etc. Heavy cargo goods vehicles can be lorries, trucks, trailers etc. Buses can be single deck, double deck, coaches, bendy buses etc. Moving images which comprise movies and videos are fragmented or split into individual still image frames and subjected to image processing routines and algorithms in the system being described and the method that is described below.

The image capture device 110 can have image processing routines and applications installed to process the captured visual information to extract an automobile registration code. The automobile registration code can be a license plate number or any such codes used for registration purposes. Alternately, the back end computing system 120 can have image processing routines and applications installed to process the captured visual information to extract an automobile registration code.

If the image processing of the visual information is performed in the image capture device 110, then the license plate number is extracted in the image capture device 110 and the extracted license plate number is transmitted to the back end computing system 120 through the transmission link 130. The image processing routines and applications are stored in a non-volatile memory module of the image capture device 110. In the mobile phone, it is accessible via a mobile app or application. If the image processing of the visual information is performed in the back end computing system 120, then the captured visual information is transmitted by the image capture device 110 to the back end computing system 120 through the transmission link 130. The image processing routines and applications are stored in a non-volatile memory module of the back end computing system 120. The image processing algorithm for extracting the license plate number is readily known and understood by a person skilled in the art.

The back end computing system 120 is configured to search the database comprising information about traffic violations against the extracted lice plate number. If there is an entry in the database with the extracted license plate number, then it means that the automobile whose visual information has been captured by the image capture device 110 has violated traffic laws earlier. If there is no entry in the database, then it means that the automobile whose visual information has been captured by the image capture device 110 has not violated traffic laws earlier. The back end computing system 120 is further configured to transmit the results of the search to the image capture device 110 with display capabilities or to the mobile apparatus in which the image capture device 110 is embedded. The advantage provided by the system is that it facilitates quick retrieval of information related to traffic violation which can be helpful to the law enforcer or the traffic policeman on patrol. Moreover, in the case of a camera in a mobile device, the law enforcer or the traffic policeman can carry the mobile device easily and carry out the operations effectively.

Representative examples of the functioning of the system 100 are provided below. In one method, the image capture device 110 captures visual information. The visual information captured is processed by the image processing application running in the image capture device 110 and the license plate number is extracted. The extracted license plate number is transmitted to the back end computing system 120 over the transmission link 130 and then the database of information associated with the traffic is searched against the license plate number. The search results or the information associated with at least one element of the traffic is transmitted back to the image capture device 110 with display capabilities or the mobile apparatus in which the image capture device 110 is embedded.

In another method, the image capture device 110 captures visual information. The visual information captured is transmitted to the back end computing system 120 over the transmission link 130 and then processed by the image processing application running in the back end computing system 120. The license plate number is then extracted. The database of information associated with the traffic is searched against the license plate number in the back end computing system 120. The search results or the information associated with at least one element of the traffic is transmitted back to the image capture device 110 with display capabilities or the mobile apparatus in which the image capture device 110 is embedded.

In an alternate embodiment, the image capture device 110 comprises the database as well, without the need for a back end computing system 120, such that the image capture, image processing and the information retrieval from the database is done in the image capture device itself.

It is to be understood that the foregoing description is intended to be purely illustrative of the principles of the disclosed techniques, rather than exhaustive thereof, and that changes and variations will be apparent to those skilled in the art, and that the present invention is not intended to be limited other than as expressly set forth in the following claims.

1. A system for capturing and retrieving information related to traffic, comprising:
an image capture device for capturing visual information of the traffic; and
a back end computing system configured to communicate with the image capture device by a transmission link, the back end computing system comprising a database of information associated with the traffic and further configured to retrieve information associated with at least one element of the traffic.

2. The system for capturing and retrieving information related to traffic as claimed in claim 1, wherein the image capture device is a camera.

3. The system for capturing and retrieving information related to traffic as claimed in claim 2, wherein the camera forms part of a mobile apparatus.

4. The system for capturing and retrieving information related to traffic as claimed in claim 3, wherein the mobile apparatus is a mobile phone.

5. The system for capturing and retrieving information related to traffic as claimed in claim 1, wherein the transmission link is a wireless transmission link.

6. The system for capturing and retrieving information related to traffic as claimed in claim 5, wherein the wireless transmission link is one of a 3G and 4G link.

7. The system for capturing and retrieving information related to traffic as claimed in claim 1, wherein the database of information associated with the traffic comprises a database of traffic violations associated with a first subset of automobiles from a totality of automobiles registered in a jurisdiction, the traffic at any point in time comprising a second subset of automobiles from the totality of automobiles registered in the jurisdiction.

8. The system for capturing and retrieving information related to traffic as claimed in claim 1, wherein one of the image capture device and the back end computing system is configured to extract an automobile registration code of the element of the traffic from the captured visual information.

9. The system for capturing and retrieving information related to traffic as claimed in claim 8, wherein the automobile registration code is a license plate number of the automobile.

10. The system for capturing and retrieving information related to traffic as claimed in claim 4, wherein one of the image capture device and the back end computing system is configured to extract an automobile registration code of the element of the traffic from the captured visual information.

11. The system for capturing and retrieving information related to traffic as claimed in claim 10, wherein the automobile registration code is a license plate number of the automobile.

12. The system for capturing and retrieving information related to traffic as claimed in claim 5, wherein one of the image capture device and the back end computing system is configured to extract an automobile registration code of the element of the traffic from the captured visual information.

13. The system for capturing and retrieving information related to traffic as claimed in claim 12, wherein the automobile registration code is a license plate number of the automobile.

14. The system for capturing and retrieving information related to traffic as claimed in claim 6, wherein one of the image capture device and the back end computing system is configured to extract an automobile registration code of the element of the traffic from the captured visual information.

15. The system for capturing and retrieving information related to traffic as claimed in claim 14, wherein the automobile registration code is a license plate number of the automobile.

16. The system for capturing and retrieving information related to traffic as claimed in claim 7, wherein one of the image capture device and the back end computing system is configured to extract an automobile registration code of the element of the traffic from the captured visual information.

17. The system for capturing and retrieving information related to traffic as claimed in claim 16, wherein the automobile registration code is a license plate number of the automobile.

18. The system for capturing and retrieving information related to traffic as claimed in claim 2, wherein one of the image capture device and the back end computing system is configured to extract an automobile registration code of the element of the traffic from the captured visual information.

19. The system for capturing and retrieving information related to traffic as claimed in claim 18, wherein the automobile registration code is a license plate number of the automobile.
